(19) United States
(12) Patent Application Publication
(10) Pub. No.: US 2020/0320573 A1
(43) Pub. Date: Oct. 8, 2020

(54) Targeted Advertising Based On Demographic Features Extracted From Vehicles And Vehicle Occupants

(71) Applicant: Howard Jason Harrison, Bethesda, MD (US)

(72) Inventor: Howard Jason Harrison, Bethesda, MD (US)

(21) Appl. No.: 16/840,976

(22) Filed: Apr. 6, 2020

Related U.S. Application Data
(60) Provisional application No. 62/829,029, filed on Apr. 4, 2019.

(51) Int. Cl. G06Q 30/02; G06K 9/32; H04B 17/318; H04W 80/02

(52) U.S. Cl. CPC G06Q 30/0266; G06Q 30/0271; G06K 9/325; G06K 2209/23; H04W 80/02; G06K 2209/15; H04B 17/318

(57) ABSTRACT

Systems and methods to determine a demographic attribute of a likely occupant of a vehicle based on a radio frequency communication from a mobile electronic device likely to be located within the vehicle, an image of the vehicle, or both, are presented herein. Furthermore, media content is selected based on the identified demographic attribute and presented to the likely occupant of the passing vehicle. In some embodiments, the media content is interactive. In another aspect, a demographic profile of likely vehicle occupants is identified based on image information, radio frequency communications, or both, gathered at a location over a period of time.

### CROSS REFERENCE TO RELATED APPLICATION

The present application for patent claims priority under 35 U.S.C. § 119 from U.S. provisional patent application Ser. No. 62/829,029, entitled “Targeted Advertising Based On Radio Frequency Communication and License Plate Recognition,” filed Apr. 4, 2019, the subject matter of which is incorporated herein by reference in its entirety.

### TECHNICAL FIELD

The described embodiments relate to systems and tools for extraction of demographic features from vehicles and vehicle occupants.

### BACKGROUND INFORMATION

License Plate Recognition (LPR) systems are typically employed to scan and log license plate information associated with vehicles in publically accessible areas. A typical LPR unit performs image analysis on captured images to identify the license plate number associated with each image. The LPR unit generates a record for each license plate number captured. The record may include any of an optical character recognition (OCR) interpretation of the captured license plate image (e.g., output in text string object format), images of the license plate number, an image or images of the vehicle associated with the license plate number, the date and time of image capture, and the location of the image capture. By operating a LPR unit for prolonged periods of time at a given location, the amount of aggregated license plate information grows.

Media displays are typically employed to deliver advertising content to viewers in a wide variety of settings. Simple, static media displays (e.g., printed or painted graphics and text) remain widely used. Typically, the content of a particular static media display is fixed for a lengthy period of time (e.g., weeks or months). In addition to static media displays, dynamic media displays have also been widely adopted. The content of dynamic media displays can be frequently refreshed. Traditionally, this ability has been utilized to display a series of advertisements so that a passerby may see more than one advertisement before the viewing opportunity ends.

Both static and dynamic media displays are typically located in highly visible areas based on the rationale that highly visible displays reach more potential customers. Moreover, specific advertising content is often displayed in a particular location based on a limited understanding of the aggregate demographic profile of viewers at that location. However, in many contexts the understanding of the demographic profile of viewers of media displays at any given time and the evolution of the demographic profile over time remains very limited. As a consequence, the effectiveness of displayed advertising content is limited. The uncertainty surrounding the effectiveness of display sign advertising generates resistance to capital investment to replace existing signs with more costly signs that provide the ability to display digital media. Improvements in the identification of a demographic profile of viewers at a particular location, its evolution over time, and the selection of interactive media content targeted to the identified demographic profile is desired.

### SUMMARY

Systems and methods to determine a demographic attribute of a likely occupant of a passing vehicle based on a radio frequency communication from a mobile electronic device likely to be located within the vehicle, an image of the passing vehicle, a license plate number, or any combination thereof, is presented herein. Furthermore, the presentation of media content to the likely occupant of the passing vehicle in response to the identified demographic attribute is also presented.

In one aspect, vehicle information associated with a passing vehicle is determined based on analysis of an image or stream of images of the passing vehicle by an artificial intelligence (AI) based model. In turn, a demographic attribute associated with a likely occupant of the vehicle is determined based on the vehicle information. In response, media content targeted to the likely occupant of the passing vehicle is selected based on the demographic attribute.

In another aspect, a demographic attribute associated with a likely occupant of a passing vehicle is determined based on a radio frequency communication from a mobile electronic device likely to be located within the passing vehicle. In response, media content targeted to the likely occupant of the passing vehicle is selected based on the demographic attribute.

In another aspect, a demographic attribute associated with a likely occupant of a passing vehicle is determined based on a license plate number identified with the vehicle and a radio frequency communication from a mobile electronic device likely to be located within the vehicle. In response, media content targeted to the likely occupant of the passing vehicle is selected based on the demographic attribute. This media content is then presented within view of the occupant of the passing vehicle.

In some embodiments, interactive media content includes an invitation to respond to the interactive media content electronically. A response to the interactive media content is received from an occupant of the vehicle. The response includes an indication that the occupant specifically recognized the interactive media content and an indication of the identity of the occupant.

Interactive media content includes an invitation to respond to the interactive media content electronically. In some embodiments, interactive media content includes a unique identifier that allows a viewer to authenticate his or her recognition of the specific interactive media content. A response received from a likely occupant includes an indication that the occupant specifically recognized the interactive media content (e.g., a code embedded in the interactive media content, etc.). In addition, the response includes an indication of the identity of the occupant (e.g., name, e-mail address, etc.). In this manner, additional interaction between an advertiser and the occupant may occur.

In one further aspect, interactive media content is communicated to a likely occupant via an electronic message directed to an electronic account associated with the likely occupant of the moving vehicle. In some examples, the likely occupant of a moving vehicle has already agreed to receive targeted advertisements based on license plate recognition and has disclosed one or more electronic accounts to associate with a particular license plate number.

In another aspect, a media presentation system 100 identifies a demographic profile of likely vehicle occupants passing a particular location based on information gathered from that location over a period of time. The gathered information includes vehicle information determined based on analysis of an image or stream of images of passing vehicles by an artificial intelligence (AI) based model, RF communications from mobile electronic devices likely to be located within the passing vehicles, LPR information, or any combination thereof. The media presentation system selects media content for presentation based on the identified demographic profile. In this manner, media content is presented to viewers that is targeted to reach segments of the identified demographic profile and is able to evolve with changes in the demographic profile.

In another further aspect, the media content selected for presentation to the occupant is also based on the estimated speed of the moving vehicle. For example, if the speed of the moving vehicle is low, the likely occupant may have more time to read media content. Hence, the selected media content may be more complex. However, if the speed of the moving vehicle is high, the likely occupant may have little time to read media content. Hence, more simplistic media content (e.g., fewer characters and figures) is selected.

In another further aspect, a demographic profile associated with likely occupants of vehicles passing a location may be identified based on repeated instances of the same vehicle, repeated instances of the same mobile electronic devices, or both, at a particular location. For example, if one or more vehicles and mobile electronic devices repeatedly pass a particular location at a similar time of day, a demographic profile of the traffic flow at that location for a particular time period may be determined. The demographic profile of the likely occupants of the passing vehicles is mapped to advertising content.

In a further aspect, media content is sequentially selected based on a periodically repeating demographic profile. For example, the demographic profile of likely occupants of vehicles passing a particular location during commute hours on a busy metropolitan freeway repeats each workday. Moreover, many of the same occupants of the passing vehicles pass the same location each workday. In response to this demographic profile, media content is sequentially selected to follow a storyline. In this manner, vehicle occupants are drawn to the advertisement each day to see the next installment of the story.

In another aspect, media content is selected based on a response to an offer to present particular media content that matches a demographic profile of likely occupants of passing vehicles that is currently trending.

The foregoing is a summary and thus contains, by necessity, simplifications, generalizations and omissions of detail. Consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a diagram illustrative of an embodiment of a media presentation system 100 in one exemplary operational scenario.

FIG. 2 is illustrative of a plurality of vehicle instances (151-157) stored in memory 150.

FIG. 3 is a diagram illustrative of a computer 110 including a processor 120 and a memory 130 that stores program instructions that, when executed by processor 120, causes processor 120 to implement media selection functionality.

FIG. 4 is illustrative of a media selection tool 105 and media messaging module 109 operable in accordance with the method of media selection 300 illustrated in FIG. 5.

FIG. 5 is a flowchart illustrative of one exemplary method 300 of media selection.

FIG. 6 illustrates a demography engine 500 configured to implement media selection functionality.

FIG. 7 illustrates a media content mapping engine 600 configured to implement media selection functionality.

### DETAILED DESCRIPTION

Reference will now be made in detail to background examples and some embodiments of the invention, examples of which are illustrated in the accompanying drawings.

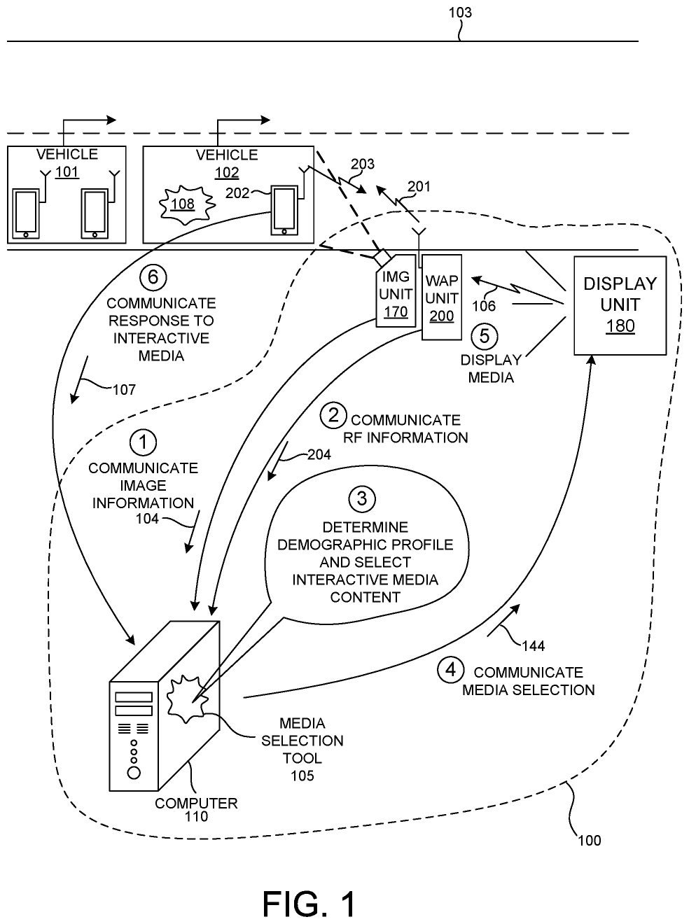

FIG. 1 is a diagram illustrative of an embodiment of media presentation system 100 in one exemplary operational scenario. Media selection system 100 includes an image unit 170, a RF wireless access point (WAP) unit 200, a display unit 180, and a general purpose computer 110 operable to implement media selection tool 105 and media messaging module 109. Image unit 170, WAP unit 200, and display unit 180 are communicatively coupled to general purpose computer 110. For example, image unit 170, WAP unit 200, and display unit 180 may be communicatively coupled to computer 110 by a wired or wireless communication link. In some embodiments, computer 110 may be collocated with any of image unit 170, WAP unit 200, and display unit 180. For example, in some embodiments, computer 110 may be a digital signal processor on board image unit 170, WAP unit 200, or display unit 180. In some other embodiments, computer 110 may be distally located from any of image unit 170, WAP unit 200, and display unit 180. For example, in some embodiments, computer 110 may be a server located at a remote facility and computer 110 may be communicatively linked to one or more distally located image units 170, WAP units 200, and display units 180 by a wired or wireless communication link.

In the embodiment illustrated in FIG. 1, image unit 170, WAP unit 200, and display unit 180 of media presentation system 100 are placed alongside a roadway 103. Passing traffic includes vehicles 101 and 102. Media presentation system 100 captures image information 104 associated with vehicles 101 and 102 as they pass image unit 170, captures RF communication information 204, and determines demographic attributes associated with likely occupants of vehicles 101 and 102 based on the image information 104 and RF communication information 204. Media presentation system 100 also generates content display instructions 144 based on the demographic attributes, and presents the selected media content 106 to vehicles 101 and 102 as they pass display unit 180. In some embodiments, the selected media content is interactive, and occupant 108 responds to the displayed interactive media content by communicating a confirmation message 107 to computer 110. The confirmation message 107 (e.g., e-mail, text message, text-based web post, etc.) includes the identity of the occupant 108 (e.g., e-mail address, phone number, web address, etc.) and an indication that the occupant 108 specifically recognized the interactive media content 106.

In the illustrated embodiment, image unit 170, WAP unit 200, and display unit 180 are in different locations. However, in other embodiments, they may be collocated. In some other embodiments, image information may be captured at roadway 103 by image unit 170 and RF information may be captured by WAP unit 200, but the selected media content may be presented elsewhere. For example, image and RF information may be captured at a roadway 103 leading to a public or private venue (e.g., shopping mall, sporting complex, tourist sites, restaurant, government or corporate complex) and the selected media content may be displayed within the public venue (e.g., inside the mall, etc.).

Image unit 170 is placed in a fixed location in view of passing vehicles (e.g., alongside a roadway, over a roadway, embedded in the surface of a roadway, etc.). Image unit 170 includes a camera module (not shown) that captures at least one image or stream of images, i.e., video, of a passing vehicle (e.g., vehicles 101 and 102). In some embodiments, image unit 170 includes image sensors with the ability to capture a set of at least two images for each passing vehicle. One image may be an infrared image useful to identify the license plate number. A second image may be an overview image of a larger area of the vehicle useful to identify vehicle characteristics. In addition, image unit 170 includes a timing module (not shown) that determines the time of image capture. Each captured image and its associated time of capture are included in image information 104 associated with a distinct vehicle capture instance. In some embodiments, image unit 170 performs image analysis on each captured image to identify the license plate number associated with the passing vehicle. In the depicted embodiment, image unit 170 communicates image information 104 associated with each vehicle instance to computer 110.

In some embodiments a number of image units 170 may be located at a particular location about roadway 103, each configured to capture images of passing vehicles from different perspectives. For example an image unit 170 may be positioned to face traffic and capture an image of oncoming vehicles. Another image unit 170 may be positioned facing the back of passing vehicles and capture an image of passing vehicles from behind. Another image unit may be positioned above roadway 103 and capture an image of the passing vehicles from an elevated perspective view. Another image unit may be embedded in the surface of roadway 103 and capture an image of the passing vehicles from ground level perspective view. In some embodiments, image units may be configured to capture images of passing vehicles in both directions of roadway 103.

In some embodiments, a location code is associated with each image unit in a fixed location. The location code may be a predetermined code that indicates the location of image unit 170. In some embodiments, image unit 170 includes a location code with image information 104 communicated to computer 110.

WAP unit 200 (e.g., router, Wi-Fi hotspot, Bluetooth hotspot, etc.) is placed in a fixed location in view of passing vehicles, typically in close proximity to image unit 170. WAP unit 200 broadcasts messages 201 inviting mobile electronic devices (e.g., mobile phones, tablets, etc.), such as mobile phone 202 located in vehicle 102 to communicate with WAP unit 200. In response, the mobile electronic devices respond with a message (e.g., message 203) indicating its MAC (media access control) address. In some embodiments, a mobile electronic device broadcasts its MAC address, periodically, without prompting. For example, mobile phones frequently broadcast a request to connect (e.g., once per minute). As depicted in FIG. 1, mobile device 202 transmits signals 203 indicating its MAC address.

In addition, WAP unit 200 receives signals from mobile electronic devices (e.g., signals 203) and determines an indication of the signal strength (e.g., Received Signal Strength Indicator (RSSI)) associated with each received signal. The signal strength is indicative of the distance between WAP 200 and the mobile electronic device. In this manner, signals received from mobile electronic devices by WAP 200 at any given time can be grouped together by their proximity to WAP 200, and thus the likelihood that one or more mobile electronic devices are located in a particular passing vehicle.

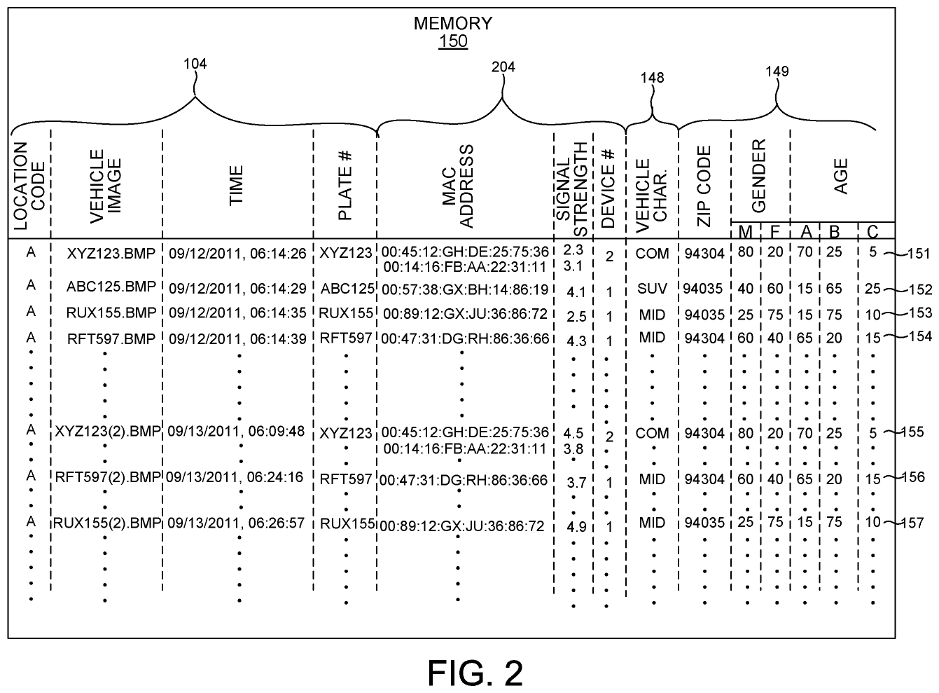

Image information 104 and RF information 204 received by computer 110 are stored in memory 150. FIG. 2 is illustrative of a plurality of vehicle instances (151-157) stored in memory 150. Each vehicle instance includes image information 104 received from image unit 170 and RF information 204 received from WAP unit 200. In addition, each vehicle instance includes vehicle information 148 and demographic information 149 derived from image information 104 and RF information 204. In the illustrated example, image information 104 includes a location code, image data (e.g., image of license plate, perspective view of vehicle, etc.) a license plate number, and the time of image capture associated with each image instance. RF information 204 includes MAC addresses received during the time between the last vehicle instance and the current vehicle instance, the signal strength associated with each received MAC address, and the likely number of mobile electronic devices located in the imaged vehicle.

In one example, image information 104 communicated from image unit 170 to computer 110 includes captured image data and the time of capture associated with each vehicle instance and additional image processing tasks are performed by computer 110. In this manner, computer 110 determines the license plate number, vehicle information 148 and demographic information 149 in combination with RF information 204 illustrated in FIG. 2. However, in some other examples, image unit 170 may perform any number of the additional image processing tasks and communicate the results to computer 110. In this manner, image unit 170 determines any of the license plate number, vehicle information 148, and demographic information 149 in combination with RF information 204 illustrated in FIG. 2.

Vehicle information (e.g., vehicle information 148) includes characteristics of a vehicle derived from the captured image information. For example, vehicle information may include the Vehicle Identification Number (VIN), the vehicle classification (e.g., compact automobile, mid-size automobile, heavy truck, medium truck, motorcycle, etc.), the vehicle make and model, vehicle color, the state associated with the license plate, and estimated vehicle value. In some examples, elements of vehicle information are determined from publically available vehicle registration records associated with the license plate number determined by image unit 170. For example, the VIN, the vehicle classification, the vehicle make and model, the vehicle color, and estimated vehicle value may be determined by computer 110 from publically available records. In some other examples, elements of vehicle information are determined from captured image information associated with each vehicle instance. For example, computer 110 may identify any of the make and model of the vehicle, the vehicle classification, and a color of the passing vehicle from overview image data. In another example, the state (e.g., Nevada, Massachusetts, etc.) associated with a particular license plate may be determined from an image recognition algorithm performed on an image of the license plate.

In some embodiments, image information 104 includes captured image data including still images, video, or both. In addition, computer 110 extracts the license plate number, vehicle information 148, demographic information 149, or any combination thereof, from the captured image data using a trained artificial intelligence (AI) based model. The AI based model is a machine learning (ML) model that has been trained on image data having known values of license plate number, vehicle information, demographic information, or any combination thereof. Exemplary ML models include a neural network model, a support vector machines model, a random forest model, a decision tree model, Bayesian model, etc.

In some examples, license plate information, vehicle information, or both, derived from AI based models is reconciled with license plate information, vehicle information, or both, derived from OCR, publically accessible databases, etc. For example, OCR and an AI based model may agree that captured image data includes a particular license plate number. However, a publically accessible vehicle registration database may indicate that the vehicle associated with the particular license plate number is a white Mercedes-Benz® SUV, while the AI based model indicates that the vehicle is a blue Dodge sedan. In this example, an alert is raised indicating the mismatch. In some examples, the mismatch indicates an error in the records of the publically accessible vehicle registration database. In some other examples, the mismatch indicates that a license plate has been illegally switched to another vehicle.

Demographic information (e.g., demographic information 149) includes demographic attributes of likely occupants of vehicles associated with each vehicle instance. For example, demographic information may include a zip code associated with the vehicle registration, the gender of the vehicle occupant, the age of the vehicle occupant, etc.

In some examples, elements of demographic information 149 are determined from publically available vehicle registration records associated with the license plate number determined by image unit 170. For example, the zip code plus four digit code of the registered owner of the vehicle may be determined from publically available vehicle registration records.

In some other examples, elements of demographic information are determined from captured RF information associated with each vehicle instance. For example, computer 110 may estimate any of the number of occupants of the vehicle, whether any of the occupants are children, the make and model of electronic devices in the vehicle based on the captured RF information associated with each vehicle instance.

In some other examples, elements of demographic information are determined from captured image information associated with each vehicle instance. For example, computer 110 may identify any of the number of occupants of the vehicle, whether any of the occupants are children, the age, gender, or race of any of the occupants of the vehicle based on image analysis of the captured image information by a trained AI model.

In some other examples, elements of demographic information are derived from vehicle information derived from the license plate number, vehicle characteristics, or both, identified for each vehicle instance. For example, any of the duration of residence at the current address, marital status, family size, number of vehicles owned, and estimated income of registered owners may be determined from publically accessible information sources (e.g., LexisNexis®, accessible at www.lexisnexis.com, TLO®, accessible at www.tlo.com, etc.) based on information gleaned from publically available vehicle registration records or vehicle characteristics identified by a trained AI model.

In another example, a number of vehicle characteristics may be collected from publically available records or by analysis by an AI model. Based on these vehicle characteristics, demographic attributes associated with likely occupant of the vehicle may be determined from publically accessible information sources (e.g., LexisNexis®, accessible at www.lexisnexis.com, TLO®, accessible at www.tlo.com, etc.).

For example, if the car is determined to be a model E350 manufactured by Mercedes-Benz®, it may be determined based on publically accessible demographic studies that 60% of the owners of this car are female, working professionals between the ages of 35 and 50 years old, 25% are male, working professionals between the ages of 35 and 50 years old, 10% are retired females between the ages of 55 and 70 years old, and the rest belong in other categories. Similarly, if the mobile electronic device is identified as an Apple® iWatch®, for example, it may be determined based on publically accessible demographic studies that 70% of the owners of this watch are female, working professionals between the ages of 35 and 50 years old, 15% are male, working professionals between the ages of 35 and 50 years old, 5% are retired females between the ages of 55 and 70 years old, and the rest belong in other categories. As illustrated in FIG. 2, the demographic attributes associated with each vehicle instance are stored in memory 150 as demographic information 149.

In one aspect, a demographic attribute associated with a likely occupant of a passing vehicle is determined based on a radio frequency communication from a mobile electronic device likely to be located within the vehicle, an image of the passing vehicle, a license plate number associated with the passing vehicle, or any combination thereof. In response, media content targeted to the likely occupant of the passing vehicle is selected based on the demographic attribute. This media content is then presented within view of the occupant of the passing vehicle. In some embodiments, the media content is interactive and includes an invitation to respond to the interactive media content electronically. A response to the interactive media content is received from an occupant of the vehicle. The response includes an indication that the occupant specifically recognized the interactive media content and an indication of the identity of the occupant.

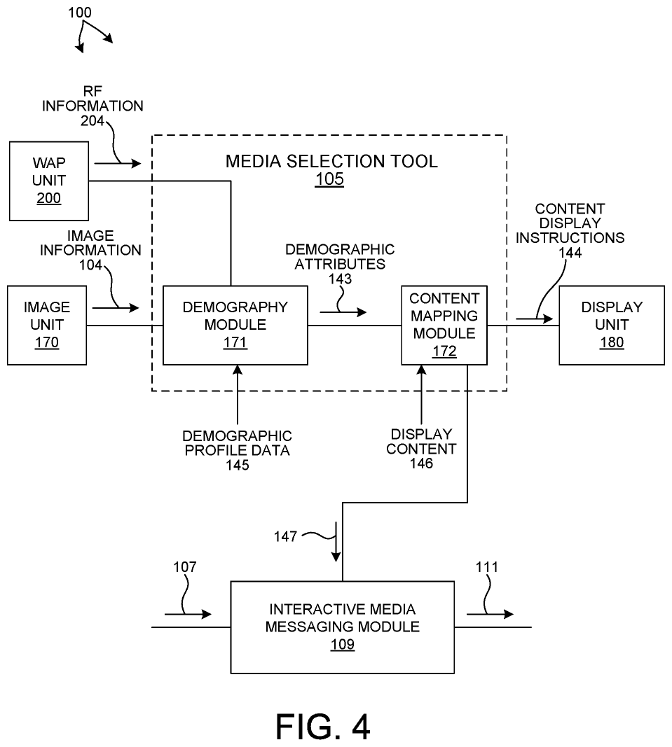

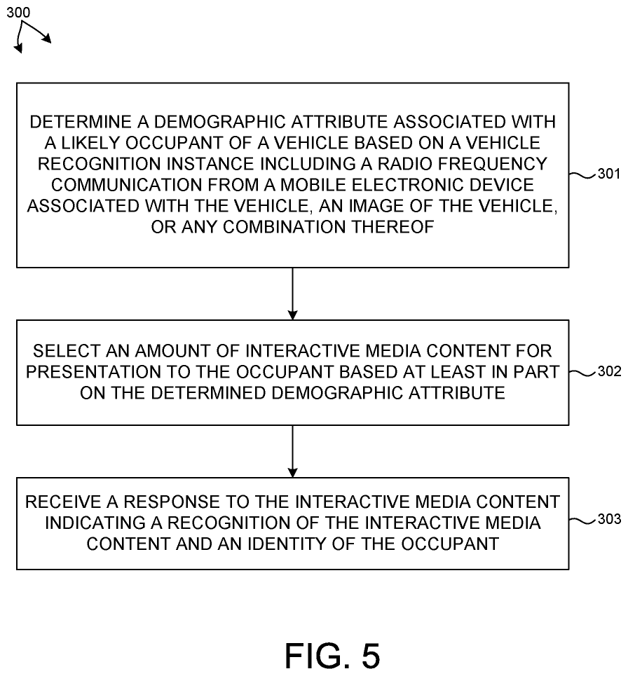

FIG. 4 is illustrative of a media selection tool 105 operable in accordance with the method of media selection 300 illustrated in FIG. 5. This illustration and corresponding explanation are provided by way of example as many other embodiments and operational examples may be contemplated.

In the depicted embodiment, interactive media selection tool 105 includes a demography module 171 and a media content mapping module 172. In the depicted embodiment, media selection tool 105 receives image information 104 from image unit 170 and RF information 204 from WAP unit 200 and communicates content display instructions 144 to display 180. In one example of block 301 of method 300, demography module 171 determines a demographic attribute associated with an occupant of a moving vehicle based at least in part on the image information, RF information, or both, associated with the passing vehicle. For example, demography module 171 may access publically available demographic profile data 145 (e.g., vehicle registration records) that indicates that the vehicle with the identified license plate number is a model E350 manufactured by Mercedes-Benz®, or process captured image information with a trained AI model to identify the make and model of the vehicle. In addition, demography module 171 may access additional publically accessible demographic profile data 145 (e.g., third party market research) that indicates that drivers of a model E350 manufactured by Mercedes-Benz are 60% female, working professionals between the ages of 35 and 50 years old, 25% male, working professionals between the ages of 35 and 50 years old, and 10% retired females between the ages of 55 and 70 years old. These demographic attributes 143 are communicated to media content mapping module 172.

In some examples, demographic profile data 145 is stored in a database stored in memory 130 of computer 110, or on a server accessible to computer 110. In this manner, the demographic profile data associated with the vehicle license plate and RF information is quickly accessible.

In one example of block 302, media content mapping module 172 selects an amount of media content for presentation based at least in part on the determined demographic attribute associated with a likely occupant of the vehicle. Media content mapping module 172 accesses display content 146 including a number of different interactive advertisements each targeted differing demographic groups. Media content mapping module 172 maps the demographic attributes of the passing car with advertisements that target those demographic attributes. For example, an advertisement for luxury wristwatches is targeted to male and female working professionals between ages 35 and 50 years old. In one example, media content mapping module 172 assigns a high score to the match between the advertisement for luxury wristwatches with the demographic attributes of the likely occupants of the passing car (e.g., 85% match). In contrast, an advertisement for low-priced alcoholic beverages does not target male and female working professionals between ages 35 and 50 years old, nor retired females between ages 55 and 70 years old. As a result, media content mapping module 172 assigns a low score (e.g., 10%) to the match between the advertisement for low-priced alcoholic beverages and the likely occupants of the passing car. Based on the assigned scores, media content mapping module 172 selects media content 106 for presentation to the occupants of the passing car. In some examples, content mapping module 172 generates content display instructions 144 that cause display unit 180 to present the selected media content 106. For example, content mapping module generates content display instructions 144 that cause display unit 180 to display the two highest ranked advertisements in rank order for five seconds each.

In some examples, display content 146 is stored in a database stored in memory 130 of computer 110, or on a server accessible to computer 110. In this manner, the display content is quickly accessible. Moreover, in some examples, the demographic score of each advertisement for each different demographic group is pre-computed and stored. In this manner, the mapping of a demographic attribute with advertisements that target those demographic attributes is quickly realized. In one example, content mapping module 172 receives an demographic attribute associated with a likely occupant of a passing vehicle. Content mapping module 172 then queries the database of display content for advertisements with a demographic score associated with that demographic attribute. In response, content mapping module 172 receives an indication of the score of each advertisement associated with that demographic attribute. Content mapping module 172 then ranks the advertisements based on their score and selects the advertisements for presentation (e.g., the highest scoring advertisements). In another example, content mapping module 172 may query the database of display content for advertisements with a demographic score above a predetermined threshold that are associated with that demographic attribute. In this manner, the number of advertisements returned to content mapping module 172 is reduced.

Interactive media content includes an invitation to respond to the interactive media content electronically. In some embodiments, interactive media content includes a unique identifier that allows a viewer (e.g., occupant 108) to authenticate his or her recognition of the specific interactive media content. For example, an interactive advertisement for a luxury wristwatch may include a promotional code. If the viewer sends an electronic message 107 (e.g., SMS message, e-mail, etc.) that includes the code, the viewer receives a discount on a future purchase of the luxury wristwatch. In some embodiments, interactive media content includes an invitation to respond physically to the interactive media content. For example, an interactive advertisement may include an invitation to signal recognition of the specific interactive media content by flashing the vehicle headlights. The flashing of the vehicle headlights is detected (e.g., by LPR unit 170) and the identity of the viewer is derived from LPR information associated with the vehicle. In response to receiving the recognition signal, a communication is transmitted to a person identified with the vehicle. For example, the person identified with the vehicle based on the flashing of the vehicle headlights and the associated image and RF information receives a discount on a future purchase of the luxury wristwatch.

In one example, a response to the interactive media content is received by computer 110 from occupant 108. The response includes an indication that the occupant specifically recognized the interactive media content (e.g., a code embedded in the interactive media content, a flashing of the vehicle headlights, etc.). In addition, the response includes an indication of the identity of the occupant (e.g., name, e-mail address, etc.), an indication of the identity of an electronic device associated with the occupant (e.g., MAC address), or both. In this manner, additional interaction between the advertiser and the occupant 108 may occur. In one embodiment, media presentation system 100 includes media messaging module 109 configured to receive the message 107 indicating that the occupant specifically recognized the interactive media content and an indication of the identity of the likely occupant.

In one further aspect, interactive media content is communicated to a likely occupant via an electronic message directed to an electronic account associated with the likely occupant of the moving vehicle. In one example, illustrated in FIG. 4, media messaging module 109 receives content display instructions 147 from media content mapping module 172 and generates an electronic message 111 (e.g., e-mail, SMS message, etc.) that includes the media content 106 selected by content mapping module 172. Module 109 communicates the electronic message to the likely occupant 108 of the moving vehicle 102 by directing the electronic message to an electronic account (e.g., e-mail account, wireless phone number, vehicle communications system such as On-Star®, etc.) associated with the likely occupant 108. In some examples, the likely occupant 108 of moving vehicle 102 has already agreed to receive targeted advertisements and has disclosed one or more electronic accounts to associate with a vehicle or license plate number. In these examples, media presentation system 100 identifies an electronic account associated with likely occupant 108 based on the image or license plate number associated with a vehicle instance.

In another further aspect, the identity of a vehicle, vehicle occupant, or an electronic device associated with the occupant is verified at a point of purchase of the advertised product. For example, a media presentation system 100 may also be located at a point of purchase (e.g., a drive-thru at a restaurant, a point of sale terminal, etc.) In some embodiments, the media presentation system 100 identifies the license plate number, MAC address of electronic device associated with a purchaser, or both, at a point of purchase. Furthermore, the identified license plate number, MAC address, or both, are linked to advertisements displayed in view of an occupant of the vehicle having the same license plate number, an occupant associated with the same electronic device, or both. In this manner, a link is established between the advertisement and a subsequent transaction associated with the advertisement.

In another aspect, a media presentation system 100 identifies a demographic profile of likely vehicle occupants passing a particular location based on image and RF information gathered at that location over a period of time. The media presentation system selects media content for presentation based on the identified demographic profile. In this manner, media content is presented to viewers that is targeted to reach segments of the identified demographic profile and is able to evolve with changes in the demographic profile.

A demographic profile associated with a group of vehicles passing a location within a particular time frame may be identified from vehicle instances associated with the passing vehicles. In response, media content targeted to the likely occupants of the passing vehicles is selected based on the demographic profile. A demographic profile of a group of passing vehicles may be determined based on identifying common demographic characteristics associated with sub-groups of passing vehicles. For example a demographic profile may be generated based on the observation that 60% of the passing vehicles identified in the time frame are luxury makes and models, 20% are medium and heavy duty trucks, and 20% are minivans. These sub-groups may be determined by demography module 171 by grouping vehicle instances associated with the particular time frame that share common elements of vehicle information 148. The demographic profile of the likely occupants of each sub-group of passing vehicles is mapped to advertising content by media content mapping module 172 based on the identified sub-groups. For example, if 60% of the passing vehicles are luxury makes and models, advertising targeting likely drivers of these vehicles is mapped with the highest priority. Advertising targeting likely drivers of medium and heavy duty trucks and minivans are assigned a lower priority.

In another aspect, a demographic profile associated with vehicles passing a location may be identified based on repeated vehicle instances associated with the same vehicle. For example, if one or more vehicles repeatedly pass a particular location at a similar time of day, on the same days of the week (e.g., every Monday through Friday), a demographic profile of the traffic flow at that location for a particular time period may be determined by demography module 171 based on repeated vehicle instances of the same vehicles. The demographic profile of the likely occupants of the passing vehicles is mapped to advertising content by media content mapping module 172.

As illustrated in FIG. 2, vehicle instance 151 indicates that a license plate number “XYZ123” was recognized by image unit 170 at 06:14:26 am on Sep. 12, 2011, and MAC addresses “00:45:12:gh:de:25:75:36” and “00:14:16:Fb:AA:22:31:11” were recognized by WAP unit 200 in the window of time when license plate number “XYZ123” was recognized. Vehicle instance 155 indicates that the same license plate number and set of MAC addresses were recognized by image unit 170 and WAP unit 200 at the same location at 06:09:48 am on Sep. 13, 2011. Similarly, repeated vehicle instances 153 and 157 associated with license plate number “RUX155” and vehicle instances 154 and 156 associated with license plate number “RFT597” are stored in memory 150.

In one example, demography module 171 selects vehicle instances of the same license plate number and MAC addresses. Based on these repeated vehicle instances of the same vehicles and likely occupants, demography module 171 identifies a demographic profile associated with likely occupants of these vehicles. For example, if the same license plate number and MAC addresses are repeatedly recognized by image unit 170 and WAP 200 each weekday at a similar time, it can be inferred that the likely occupant of the vehicle is employed. In addition, based on the location of the image unit 170 and WAP unit 200 and publically available information about surrounding businesses, the type of employment may be inferred. The demographic profile of the likely occupants of the passing vehicles is mapped to advertising content by media content mapping module 172.

In another example, repeated vehicle instances are identified as “local,” whereas singular vehicle instances are identified as “transitory.” The demographic profile of the likely occupants of “local” vehicles is identified with that of the local community. The resulting profile is mapped to advertising content by media content mapping module 172.

In a further aspect, media content is sequentially selected based on a periodically repeating demographic profile. For example, the demographic profile of likely occupants of vehicles passing a particular location during commute hours on a busy metropolitan freeway repeats each workday. Moreover, many of the same occupants of the passing vehicles pass the same location each workday. In response to this demographic profile, media content mapping module 172 sequentially selects media content that follows a storyline. In this manner, vehicle occupants are drawn to the advertisement each day to see the next installment of the story.

In addition to demographic data, general traffic statistics can be accumulated by media presentation system 100. For example, a cumulative count of passing vehicles can be generated. In another example, a cumulative count of each identified vehicle classification can be generated. For example, the number of passing heavy trucks, medium trucks, cars, and motorcycles may be tracked over time. This information may be useful for road maintenance planning purposes. In another example, a cumulative count of the number of vehicles manufactured by a particular maker (e.g., Mercedes-Benz®) is generated by demography module 171.

In addition, the speed of passing vehicles may be estimated by media presentation system 100. This information may be useful for road capacity planning and projections. For example, commute patterns may be studied based on the average speed of passing vehicles. The speed of vehicles passing a location at a particular time may be identified based on the time between successive vehicle instances. In one example, demography module 171 determines an average time between successive vehicle instances at a particular location. For example, a small average time between successive vehicle instances would indicate high traffic density moving at normal speed. A large average time between successive vehicle instances would indicate either sparse traffic flow at normal speed or a traffic jam (e.g., very high traffic density, but low speed). To differentiate between these two possible scenarios, demography module 171 determines a measure of variance (e.g., standard deviation) of the time between successive vehicle instances. A high variance would indicate a sparse traffic flow moving at normal speeds because the time between each passing vehicle is inconsistent for sparse traffic. In contrast, a low variance would indicate a high density traffic flow because the time between successive vehicle instances is very consistent (i.e., low variance).

In a further aspect, the amount of media content selected for presentation to the occupant is also based on the estimated speed of the moving vehicle. For example, if the speed of the moving vehicle is low, the likely occupant may have more time to read interactive media content displayed on display 180. Hence, the selected media content may be more complex. However, if the speed of the moving vehicle is high, the likely occupant may have little time to read media content displayed on display 180. Hence, more simplistic media content (e.g., fewer characters and figures) is selected.

In some embodiments, media content mapping module 172 receives demographic attributes 143 and an indication of the speed of moving vehicle 102. In one embodiment, an indication of the speed of moving vehicle 102 may be generated by demography module 171 and communicated to media content mapping module 172. In some other embodiments, the indication of the speed of moving vehicle 102 is generated by an external system (e.g., inductive sensors embedded in the roadway, a radar system, etc.) and communicated to media content mapping module 172 executed by a processor of computer 110. Media content mapping module 172 selects an amount of media content for presentation based at least in part on the determined demographic attribute associated with a likely occupant of the vehicle and the estimated speed of the moving vehicle. In some examples, media content is scored based on its complexity (e.g., the time it takes for a viewer to capture the essence of the advertisement). In one example, media content mapping module 172 assigns a low score to the match between complex media content and a vehicle moving at high speed and a high score to the match between complex media content and a vehicle moving at low speed. Media content mapping module 172 selects media content 106 for presentation to the occupants of the passing car based at least in part on the assigned scores.

In yet another aspect, a demographic profile associated with vehicles passing a location at a particular time may be identified based on the time between successive vehicle instances. In one example, demography module 171 determines that a high density traffic flow exists at a particular location based on the time between successive vehicle instances as discussed hereinbefore. The likely occupants of passing vehicles in the high density traffic flow are likely to be apprehensive and irritated. Based on this demographic attribute, content mapping module 172 selects advertising content targeted to apprehensive and irritated people (e.g., advertisements for resort vacations).

In yet another aspect, media content is selected based on a response to an offer to present particular interactive media content that matches a demographic profile of likely occupants of passing vehicles that is currently trending. For example, demography module 171 may determine that a demographic profile has developed and will likely persist for a period of time. For example, based on a current demographic profile that matches the demographic profile at this location every Monday through Friday at this time, demography module 171 determines that the current demographic profile will persist (e.g., 60% males, hourly employed will be passing for the next hour). In response to this demographic prediction, media content mapping module 172 communicates an offer to an advertising entity to display particular advertising content targeting this demographic for the next hour. In response to receiving an affirmative response to the offer, content mapping module 172 generates content display instructions 144 that cause display unit 180 to display the advertising content.

In another aspect, different locations are ranked based on the demographic profile determined from image and RF information captured from traffic flows past each location. In one example, image and WAP units are located in different places (e.g., different roadways, next to different billboards, etc.). Vehicle information is captured from traffic flows past each location. A demographic profile of the traffic flow past each location is determined based on image and RF information as discussed hereinbefore. For example a demographic profile of a traffic flow at a first location may be generated based on the observation that 60% of the passing vehicles identified in the time frame are luxury makes and models, 20% are medium and heavy duty trucks, and 20% are minivans. A demographic profile of a traffic flow at a second location may be generated based on the observation that 10% of the passing vehicles identified in the time frame are luxury makes and models, 40% are medium and heavy duty trucks, and 50% are passenger vehicles. In some examples, the relative value of each different location with respect to particular advertising content is determined based on the demographic profile. For example, the demographic profile of the first location includes a relatively high percentage of luxury vehicles. Hence the first location is ranked higher than the second location for advertisements of luxury products. In this manner, the relative value of different advertising locations is assessed based on the demographic profile of traffic flows past each location determined based on image and RF information. In a further example, media content targeted to the likely occupants of the passing vehicles is selected based on the demographic ranking. For example, content mapping module 172 determines that an advertisement for a luxury product should be presented at the first location, rather than the second location based on the identified demographic ranking.

It should be recognized that the various steps described throughout the present disclosure may be carried out by a single computer system 110 or, alternatively, a multiple computer system 110. Moreover, different subsystems of a media presentation system 100 may include a computer system suitable for carrying out at least a portion of the steps described herein. Therefore, the description presented herein should not be interpreted as a limitation on the present invention but merely an illustration. Further, the one or more computer systems 110 may be configured to perform any other step(s) of any of the method examples described herein.

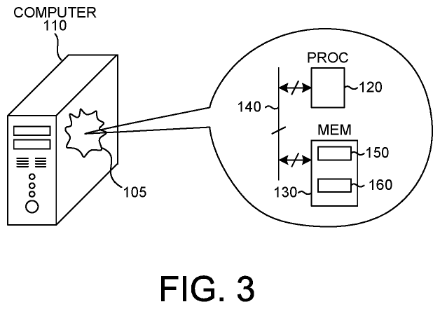

The computer system 110 may be configured to receive and/or acquire data or information from the subsystems of the media presentation system 100 (e.g., image unit 170, WAP unit 200, publically available information databases, media content databases, RF databases, LPR databases, etc.) by a transmission medium that may include wireline and/or wireless portions. In this manner, the transmission medium may serve as a data link between the computer system 110 and other subsystems. Further, the computing system 110 may be configured to receive parameters or instructions via a storage medium (i.e., memory). For example, as illustrated in FIG. 3, computer 110 includes a processor 120 and a memory 130. Processor 120 and memory 130 may communicate over bus 140. Memory 130 includes an amount of memory 160 that stores program instructions that, when executed by processor 120, causes processor 120 to implement media selection functionality by operation of media selection tool 105 and media messaging functionality by operation of media messaging module 109. In addition, memory 130 includes an amount of memory 150 that stores a number of vehicle instances. In another example, vehicle instances are stored in a database on an external server. In this regard, signals indicative of the vehicle instances may be imported from an external system.

Moreover, the computer system 110 may send data to external systems via a transmission medium. The transmission medium may include wireline and/or wireless portions. In this manner, the transmission medium may serve as a data link between the computer system 110 and other subsystems or external systems. For example, computer system 110 may send results generated by computer system 110 to external systems or to other subsystems of via a transmission medium.

The computing system 110 may include, but is not limited to, a personal computer system, mainframe computer system, workstation, image computer, parallel processor, or any other device known in the art. In general, the term “computer system” may be broadly defined to encompass any device having one or more processors, which execute instructions from a memory medium.

Program instructions implementing methods such as those described herein may be transmitted over or stored on a carrier medium (e.g., memory 160). The carrier medium may be a transmission medium such as a wire, cable, or wireless transmission link. The carrier medium may also include a computer-readable medium such as a read-only memory, a random access memory, a magnetic or optical disk, or a magnetic tape.

Method 300 may be executed by media selection tool 105 and media messaging module 109 running within computer 110. An operator may interact with media selection tool 105 via a locally delivered user interface (e.g., GUI displayed by terminal equipment directly connected to computer 110). In other embodiments, an operator may interact with media selection tool 105 via a web interface communicated over the internet.

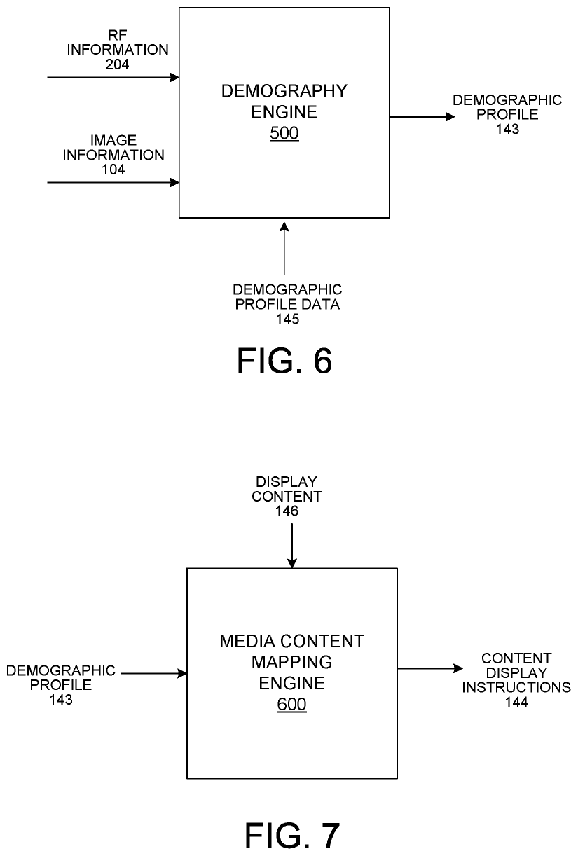

Although, method 300 may be executed by media selection tool 105 and media messaging module 109 running within computer 110, it may also be executed in part by dedicated hardware. FIG. 6 illustrates a demography engine 500 configured to implement media selection functionality as discussed herein. In one example, demography engine 500 receives image information 104, RF information 204, and demographic profile data 145 as input. Demography engine 500 implements media selection functionality as discussed herein and generates a demographic profile 143.

Although, method 300 may be executed by media selection tool 105 running within computer 110, it may also be executed in part by dedicated hardware. FIG. 7 illustrates a media content mapping engine 600 configured to implement media selection functionality as discussed herein. In one example, media content mapping engine 600 receives a demographic profile 143 and display content 146 as input. Media content mapping engine 600 implements interactive media selection functionality as discussed herein and generates content display instructions 144 useable to command a display unit 180 to display particular media content 106.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. For example, selected media may be presented by a display unit 180, however, in other examples, selected media may be presented by targeted e-mails or conventional mailings based on the identified demographic profile. Accordingly, various modifications, adaptations, and combinations of various features of the described embodiments can be practiced without departing from the scope of the invention as set forth in the claims.

What is claimed is:

1. A method comprising:
determining a demographic attribute associated with a likely occupant of a vehicle based on a vehicle recognition instance including a radio frequency communication from a mobile electronic device associated with the vehicle, an image of the vehicle, or any combination thereof;
selecting an amount of interactive media content for presentation to the likely occupant based at least in part on the determined demographic attribute; and
receiving a response to the interactive media content indicating a recognition of the interactive media content and an identity of the likely occupant.

2. The method of claim 1, further comprising:
determining a license plate number associated with the vehicle from the image of the vehicle; and
determining a time when the image of the vehicle was captured at a fixed location.

3. The method of claim 1, wherein the interactive media content includes an invitation to respond to the interactive media content electronically.

4. The method of claim 3, wherein the invitation to respond includes a code that identifies the invitation, and wherein the response indicating the recognition of the interactive media content includes the code.

5. The method of claim 1, further comprising:
communicating the amount of interactive media content to the likely occupant via an electronic message directed to an electronic account associated with the likely occupant of the moving vehicle.

6. The method of claim 1, further comprising:
receiving an indication of a speed of the moving vehicle, wherein the selecting the amount of interactive media content for presentation to the occupant is also based at least in part on the speed of the moving vehicle.

7. The method of claim 2, wherein the determining of the demographic attribute involves determining a characteristic of the moving vehicle based on the amount of image information.

8. The method of claim 7, wherein the characteristic of the moving vehicle is any of a make and model of the moving vehicle, a classification of the vehicle, and a color of the moving vehicle.

9. The method of claim 2, further comprising:
presenting the amount of selected interactive media content on a display system.

10. The method of claim 9, wherein the display system is at the fixed location.

11. The method of claim 2, wherein the determining of the demographic attribute associated with the moving vehicle involves associating publically available demographic information identified with the license plate number or analyzing the image of the vehicle by a trained artificial intelligence model.

12. The method of claim 7, wherein the determining of the demographic attribute associated with the moving vehicle involves associating publically available demographic information identified with the determined characteristic of the moving vehicle.

13. The method of claim 1, further comprising:
determining a demographic profile based on a plurality of determined demographic attributes each associated with a different vehicle recognition instance.

14. The method of claim 13, wherein the selecting of the amount of interactive media content for presentation is based at least in part on the determined demographic profile.

15. A media presentation system comprising:
an image capture device capturing one or more images of a moving vehicle;
a radio frequency (RF) device receiving a radio frequency (RF) communication indicative of a strength of signal and a MAC address of a mobile electronic device in proximity of the moving vehicle; and
a computing system configured to:
determine one or more characteristics of the moving vehicle from the one or more images of the moving vehicle based on a trained artificial intelligence (AI) model;
determine a demographic attribute of a likely occupant of the moving vehicle based at least in part on the one or more characteristic of the moving vehicle, the MAC address, or any combination thereof; and
determine an amount of media content for presentation to the likely occupant of the moving vehicle based at least in part on the determined demographic attribute.

16. The media presentation system of claim 15, wherein the media content includes an invitation to respond to the media content electronically.

17. The media presentation system of claim 15, the computing system further configured to:
communicate the amount of media content to the likely occupant via an electronic message directed to an electronic account associated with the likely occupant of the moving vehicle.

18. A media presentation system comprising:
an image module operable to determine a characteristic of a moving vehicle;
a wireless access point module operable to receive a radio frequency (RF) communication indicative of a strength of signal and a MAC address of a mobile electronic device in proximity of the moving vehicle;
a demography module operable to determine a demographic attribute of a likely occupant of the moving vehicle based at least in part on the characteristic of the moving vehicle, the MAC address, and the strength of signal; and
a media content mapping module operable to determine an amount of media content for presentation based at least in part on the determined demographic attribute.

19. The media presentation system of claim 18, further comprising:
an LPR based interactive media messaging module operable to receive a response to the media content indicating a recognition of the media content and an identity of the likely occupant, wherein the media content includes an invitation to respond to the media content electronically.

20. The media presentation system of claim 18, wherein the media messaging module is further operable to communicate the amount of media content to the likely occupant via an electronic message directed to an electronic account associated with the likely occupant of the moving vehicle.
